(19) United States
(12) Patent Application Publication
(10) Pub. No.: US 2008/0316994 A1
(43) Pub. Date: Dec. 25, 2008

(54) Synchronization in a mobile communications network

(75) Inventors: Peter Keevill, Bath (GB); Edward Hatala, Devizes (GB)

Correspondence Address: BEYER WEAVER LLP, P.O. BOX 70250, OAKLAND, CA, 94612-0250, US

(73) Assignee: UbiquiSys Limited

(21) Appl. No.: 11/890,301

(22) Filed: Aug. 2, 2007

(30) Foreign Application Priority Data
Jun. 22, 2007 (GB) 0712255.9

(51) Int. Cl. H04J 1/00

(52) U.S. Cl. 370/343

(57) ABSTRACT

A basestation, for example a femtocell basestation for use in a mobile communications network, has a frequency synthesizer, for generating signals at desired frequencies, and also has a wireless communications interface, for transmitting and receiving signals in the mobile communications network. The femtocell basestation also has a packet data interface, for transmitting and receiving packet data signals over a wide area network. The basestation is adapted to receive a signal from a first other basestation of the mobile communications network over the wireless communications interface, and to synchronize the frequency synthesizer with the signals received from the first other basestation of the mobile communications network, and to transmit a signal to a second other basestation of the mobile communications network over the packet data interface, such that the second other basestation of the mobile communications network is able to synchronize its frequency synthesizer with the signals transmitted from the basestation.

This invention relates to a mobile communications network, and in particular to a system for maintaining frequency synchronization between the basestations of such a network.

In a mobile communications network, including multiple basestations, where a mobile communications device may need to be able to establish wireless communications with any of those basestations depending on its location, it is necessary for the basestations to maintain frequency synchronization. That is, when a particular frequency is allocated for transmissions to or from a basestation, it needs to be able to ensure that it is able to receive or transmit on the allocated frequency, with a very high degree of accuracy.

In a conventional mobile communications network, each of the basestations is provided with a highly accurate and stable crystal oscillator, which is able to maintain the required degree of frequency synchronization.

However, in the case of so-called femtocell basestations, which are intended to be located within a customer's home or small office premises and to provide mobile communications services to a relatively small number of mobile communications devices, such highly accurate and stable crystal oscillators are prohibitively expensive.

U.S. Pat. No. 6,975,877 discloses a wireless network, in which a master clock signal is used to generate a clock signal in one base station, and a sync pulse is transmitted over the wireless network to other base stations in a first cluster of base stations. One of these base stations in the first cluster of base stations then propagates the sync pulse over the wireless network to other base stations in a second cluster of base stations.

According to a first aspect of the present invention, there is provided a basestation, for use in a mobile communications network, the basestation comprising:
a frequency synthesizer, for generating signals at desired frequencies;
a wireless communications interface, for transmitting and receiving signals in the mobile communications network; and
a packet data interface, for transmitting and receiving packet data signals over a wide area network,
wherein the basestation is adapted to receive a signal from a first other basestation of the mobile communications network over said wireless communications interface, and to synchronize the frequency synthesizer with the signals received from the first other basestation of the mobile communications network; and
wherein the basestation is adapted to transmit a signal to a second other basestation of the mobile communications network over said packet data interface, such that the second other basestation of the mobile communications network is able to synchronize its frequency synthesizer with the signals transmitted from the basestation.

The use of such basestations therefore allows frequency synchronization to be propagated through the network, even to basestations that are not able to detect wireless transmissions from other basestations.

For a better understanding of the present invention, and to show how it may be put into effect, reference will now be made, by way of example, to the accompanying drawings, in which:

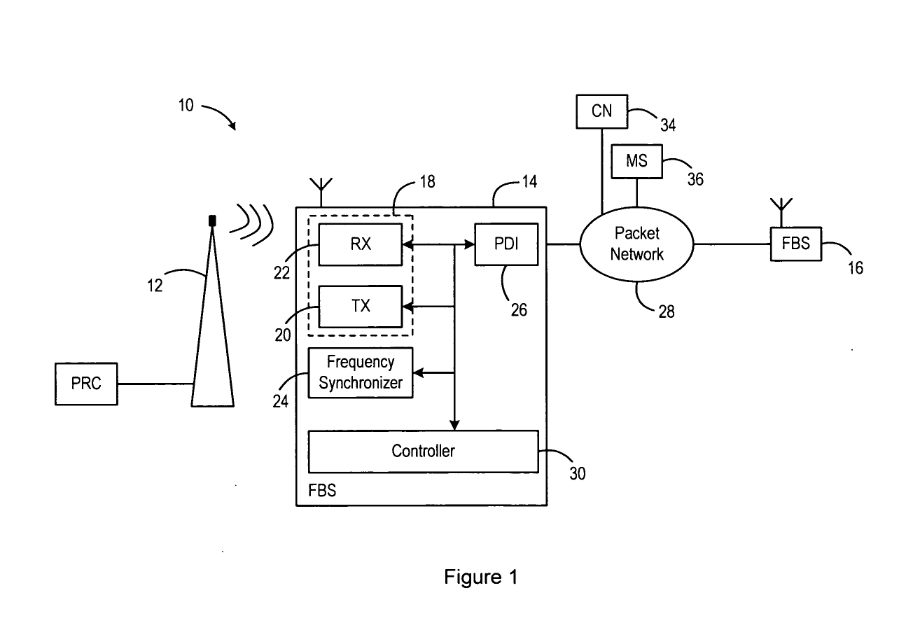

FIG. 1 shows a part of a mobile communications network in accordance with an aspect of the present invention;

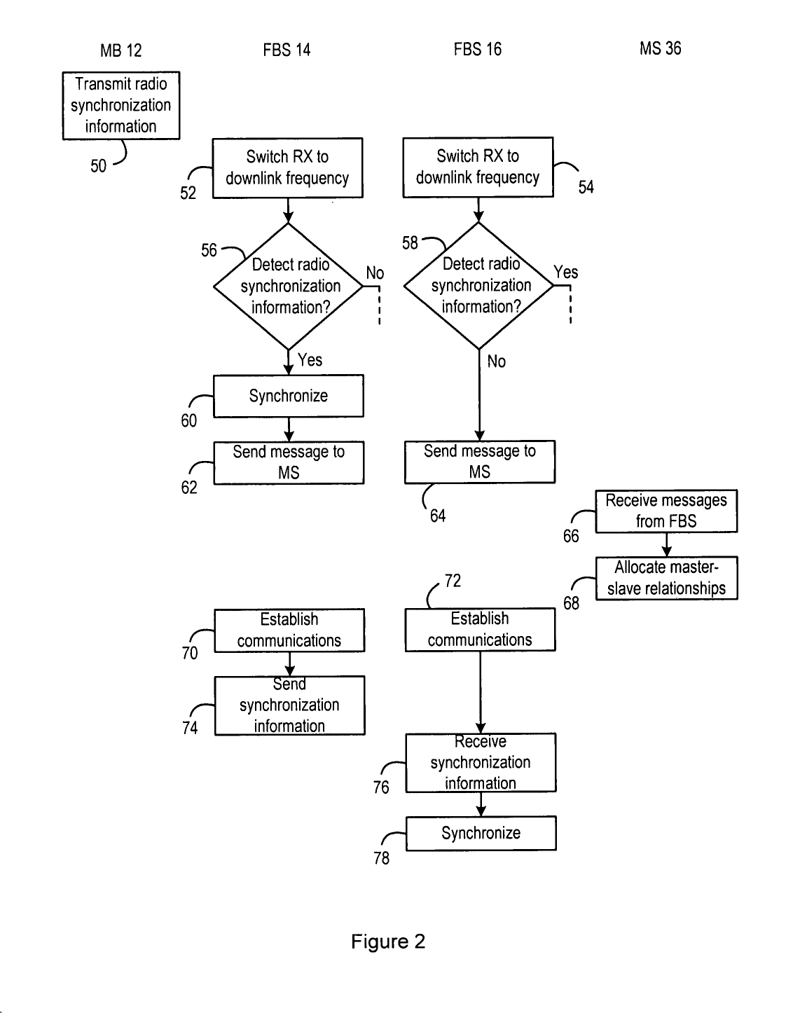

FIG. 2 is a flow chart, illustrating a method in accordance with the invention;

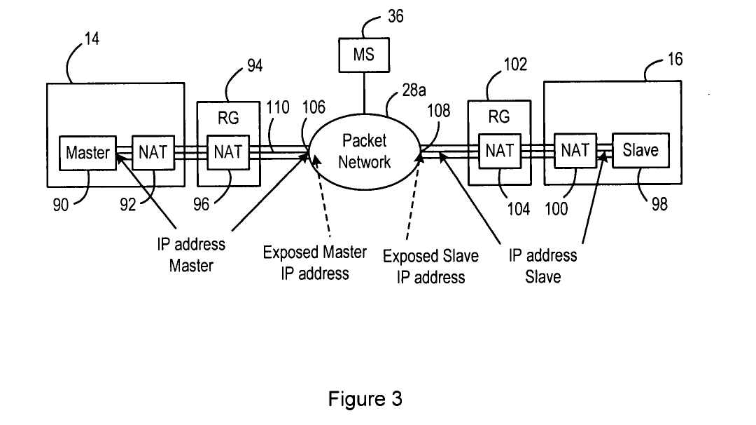

FIG. 3 is a schematic diagram, illustrating a first packet data connection in accordance with the invention;

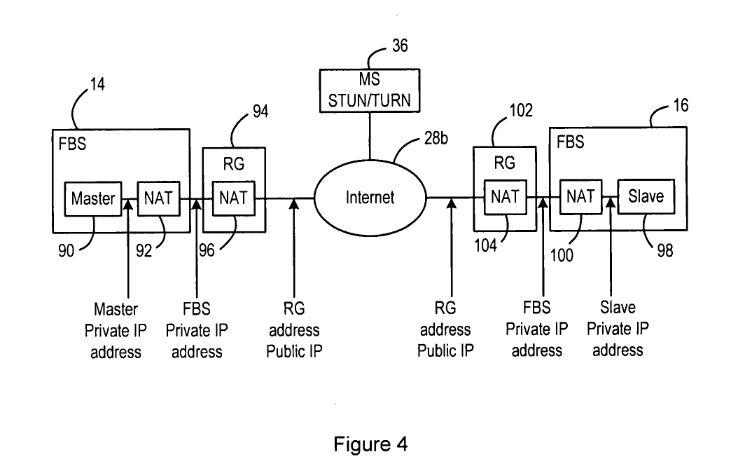

FIG. 4 is a schematic diagram, illustrating a second packet data connection in accordance with the invention;

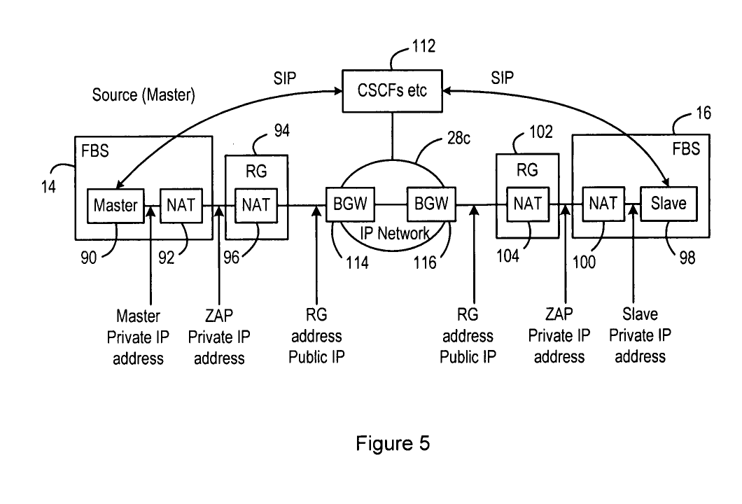

FIG. 5 is a schematic diagram, illustrating a third packet data connection in accordance with the invention.

FIG. 1 is a schematic diagram, illustrating a part of a mobile communication network 10. Aspects of the invention are applicable to networks of different types, but the invention is described herein with reference to its use in a cellular mobile communications network, in which mobile communications devices are able to communicate by means of a network of basestations.

The network 10 includes a relatively large number of basestations, such as the basestation 12, which, together, are intended to provide coverage to most or all of a relatively large geographical area. The area served by each of these basestations is typically referred to as a cell. In a typical network, the network operator may provide basestations that together serve the whole of the relatively large geographical area, with the cells served by these basestations being referred to as macrocells. The network operator may also provide additional basestations that serve particular small parts of that relatively large geographical area where network traffic levels are expected to be particularly high, such as in city centres, with the cells served by these basestations being referred to as microcells. Each of these basestations has a connection into the core network of the mobile communications network, provided by the mobile network operator.

Any subscriber of the network 10 is then able to move around within the area served by these basestations, with the associated mobile communications device being able to establish a connection with the appropriate one of the basestations, and the network being able to handover this connection from one basestation to another as the mobile communications device continues to move.

In addition, femtocell basestations are proposed, which allow a customer of the mobile communications network to set up a basestation of the mobile communications network within his own premises, such as a home or a small office. The femtocell basestation operates using the same communication frequencies as the other basestations of the network, allowing the same mobile communications devices to establish connections with them. The femtocell basestation uses the customer's existing broadband internet connection to establish a connection to the mobile network operator's core network, thereby reducing the need for the mobile network operator to build this part of the infrastructure required to increase network capacity. Each femtocell basestation may be set up so that it can provide a service only to previously registered mobile communications devices, for example devices owned by the same customer of the mobile communications network.

In the network 10, shown in FIG. 1, there are two such femtocell basestations (FBS) 14, 16.

The femtocell basestation 14 is shown in detail in FIG. 1, but it will be understood that the femtocell basestation 16 is generally similar.

The femtocell basestation 14 includes a wireless communications interface 18, for transmitting and receiving signals in the mobile communications network. As shown in FIG. 1, the wireless communications interface 18 includes transmit circuitry (TX) 20 for transmitting signals to registered mobile communications devices within the coverage area of the femtocell basestation 14, and receive circuitry (RX) 22 for receiving signals from the registered mobile communications devices within the coverage area.

Each of the transmit circuitry (TX) 20 and receive circuitry (RX) 22 must be able to operate at a desired frequency, to a high degree of accuracy, in order that transmissions can be successfully received. In normal operation of the basestation 18, the transmit circuitry (TX) 20 operates at one of the available system downlink frequencies, while the receive circuitry (RX) 22 operates at one of the available system uplink frequencies.

As shown in FIG. 1, each of the transmit circuitry (TX) 20 and receive circuitry (RX) 22 receives signals from a frequency synthesizer 24, which generates signals at desired frequencies. The frequency synthesizer 24 may for example contain a crystal oscillator, the frequency of oscillation of which can be used in a conventional way to generate the desired frequencies.

As also shown in FIG. 1, the femtocell basestation 14 includes a packet data interface (PDI) 26, for transmitting and receiving packet data signals over a wide area packet data network 28. In the embodiment shown in FIG. 1, the packet data interface (PDI) 26 is able to transmit and receive packet data signals over the internet.

As also shown in FIG. 1, the femtocell basestation 14 includes a controller 30, with the controller 30, wireless communications interface 18, the frequency synthesizer 24 and the packet data interface (PDI) 26 being able to communicate with each other as required, for example by means of an internal communications bus 32.

As discussed above, the femtocell basestations 14, 16 are able to send traffic to and receive traffic from a core network (CN) 34 of the mobile communications network 10 over the internet by means of their respective packet data interfaces 26. The mobile communications network 10 also contains a management system 36, which is also able to communicate with each of the femtocell basestations 14, 16 over the internet by means of their respective packet data interfaces 26. In this way, the management system 36 is able to monitor and or control various aspects of the operation of the femtocell basestations 14, 16.

As mentioned above, one important aspect of the operation of a basestation concerns the frequency synchronization within the network. The available communications bandwidth is divided into relatively narrow frequency channels, which means that, when a particular frequency channel is allocated for transmissions between a basestation and a mobile communications device, the transmissions must take place at a frequency that is extremely close to the allocated frequency, in order that the receiving device can correctly receive and decode the transmitted signal, and in order that the transmissions do not interfere with other signals being transmitted by other devices.

As shown in FIG. 1, the macrocell basestation 12 has access to a primary rate clock (PRC) 38, which may for example take the form of a highly accurate frequency synthesizer, for example containing a crystal oscillator whose accuracy can be maintained over long time periods and in a wide range of operating conditions. For example, the PRC 38 may contain a crystal oscillator whose frequency of operation is compensated for any changes in operating temperature, and whose operating temperature is controlled such that such changes are in any event minimized.

However, such crystal oscillators are expensive, and the frequency synthesizer 24 in the femtocell basestation 14, as well as the corresponding frequency synthesizer in the femtocell basestation 16, typically contain much less accurate crystal oscillators.

FIG. 2 is a flow chart, illustrating a method of achieving frequency synchronization between basestations of the mobile communications network 10, including actions taken by the macrocell basestation 12, the femtocell basestations 14, 16, and the management system 36.

In step 50 of the method, the macrocell basestation 12 transmits radio synchronization information. This radio synchronization information is conventional, and is generally provided such that mobile communications devices within the coverage area of the macrocell basestation 12 are able to detect the information and achieve frequency synchronization with their serving macrocell basestation.

In steps 52, 54 of the method, the femtocell basestations of the network, such as the femtocell basestations 14, 16, switch their operations such that they are able to detect signals transmitted on the system downlink frequencies, such as the frequency on which the radio synchronization information is transmitted by the macrocell basestation 12. In one embodiment of the invention, the receive circuitry (RX) 22 is able to switch such that, instead of operating at one of the available system uplink frequencies for detecting signals from mobile communications devices, it is able instead to detect signals at one of the available system downlink frequencies. This switch of operation is then controlled such that it takes place at a time when it does not interrupt normal operation of the femtocell basestation. In another embodiment, the femtocell basestation includes separate receive circuitry for detecting the radio synchronization information.

In steps 56, 58 of the method, the femtocell basestations of the network, such as the femtocell basestations 14, 16, determine whether they are able to detect the radio synchronization information transmitted by the macrocell basestation 12, or transmitted by any other basestation of the network.

For the purposes of this illustrative example, it will be assumed that the femtocell basestation 14 is one of the femtocell basestations in the network that is able to detect the radio synchronization information transmitted by the macrocell basestation 12, while the femtocell basestation 16 is one of the femtocell basestations in the network that is unable to detect radio synchronization information transmitted by any macrocell basestation.

In step 60, the femtocell basestation 14 synchronizes its operations based on the received radio synchronization information. For example, it may apply a (further) correction to the signals generated by its frequency synthesizer 24, in order that the frequencies of such signals correspond with the intended frequencies, to the required high degree of accuracy. This process is the same as that used conventionally by a mobile communications device to achieve synchronization with its serving basestation.

Thereafter, in step 62, the femtocell basestation 14 sends a message to the management system 36, informing it that it has detected the radio synchronization information transmitted by the macrocell basestation 12. Also, in step 64, the femtocell basestation 16 sends a message to the management system 36, informing it that it has not detected radio synchronization information transmitted by any macrocell basestation. The messages from the femtocell basestations 14, 16 can preferably be sent to the management system 36 over the internet via the respective packet data interfaces.

In step 66, the management system 36 detects the messages sent by the femtocell basestations 14, 16, and thus is able to determine which femtocell basestations are able to detect radio synchronization information, and which are not. It will be appreciated that the femtocell basestations can alternatively, if desired, be configured to send a message to the management system only if they are able to detect radio synchronization information, or only if they are unable to detect radio synchronization information, as the management system 36 will still be able to determine which femtocell basestations are able to detect radio synchronization information, and which are not.

In step 68, the management system 68 allocates master/slave synchronization relationships to some or all of the femtocell basestations, such that each femtocell basestation that is unable to detect radio synchronization information transmitted wirelessly from the macrocell basestations is able to receive synchronization information from one of the femtocell basestations that is able to detect radio synchronization transmitted wirelessly from the macrocell basestations, and thus will have been able to synchronize its operation using this radio synchronization information.

In this illustrative example, where the femtocell basestation 14 is one of the femtocell basestations in the network that is able to detect the radio synchronization information transmitted by the macrocell basestation 12, while the femtocell basestation 16 is one of the femtocell basestations in the network that is unable to detect radio synchronization information transmitted by any macrocell basestation, the femtocell basestation 14 is assigned to be a master for the femtocell basestation 16, which is thus assigned to be a slave.

In assigning the master-slave relationships, the management system 36 can take account of its knowledge of the physical locations of the femtocell basestations, and its knowledge of the Internet Service Provider (ISP) through which each femtocell basestation is connected to the internet. Based on this information, the management system can for example allocate synchronization master devices to slave devices in ways which minimize their separation. For example, the management system can for example allocate to a slave device a synchronization master device that is served by the same Internet Service Provider (ISP) and that is as geographically close as is possible. More specifically, the slave device and master device may advantageously be connected to the same Digital Subscriber Line Access Multiplexer (DSLAM), which will reduce the latency and/or jitter in the transmission of the signals from the master device to the slave device.

In addition, it would be preferable to ensure that each assigned “slave” has at least two “masters” in order to provide a degree of redundancy, for example if one of the “masters” itself become inaccurate. Further, it would be preferable for each assigned “master” not to be allocated more than, say, two or three “slaves”, in order to avoid placing excessive loads on the assigned “masters”.

In steps 70 and 72, the femtocell basestations establish a communications path, as will be described in more detail below. Then, in step 74, the assigned “master” femtocell basestation 14 sends synchronization information to the assigned “slave” femtocell basestation 16, which it in turn receives in step 76. For example, the synchronization information can take the form of data packets, each containing a timestamp indicating a sending time, as measured at the “master” device.

By receiving these data packets, measuring the difference between their detected arrival times, and comparing this difference with the difference between the timestamps, the “slave” device is able to compare its own clock with that contained in the “master” device. Thus, in step 78, the “slave” device is able to synchronize to the “master” device.

As an aid to resilience, a mechanism may be provided whereby, if the “slave” device suddenly detects a difference between its own clock and that of the “master” device that exceeds a particular threshold, it acts on the assumption that there is a problem with the synchronization information received from the “master” device, and switches to an alternative “master” device assigned by the management system 36.

It will be appreciated that FIG. 2 is purely schematic, and illustrates steps taken by the different network nodes at different times. For example, the macrocell basestation 12 may transmit radio synchronization information continuously or periodically at all times; and the femtocell basestations 14, 16 may each be attempting to detect such radio synchronization information at different times, for example on powering up or at periodic intervals thereafter.

As described above, when two of the femtocell basestations have been assigned to be a master device and an associated slave device, it is necessary to establish a connection between them.

One possibility is for this connection to be established in the network operator's secure packet data network 28a by means of an IPSec connection, as shown in FIG. 3.

As shown in FIG. 3, the femtocell basestation 14 contains a “master” software application 90, connected to a NAT (Network Address Transversal) device 92, and is connected to the packet data network 28a through a Residential Gateway (RG) 94, for example, a DSL router in the customer's premises. This also contains a NAT (Network Address Transversal) device 96. Similarly, the femtocell basestation 16 contains a “slave” software application 98, connected to a NAT (Network Address Transversal) device 100, and is connected to the packet data network 28a through the respective Residential Gateway (RG) 102, which also contains a NAT (Network Address Transversal) device 104.

In alternative embodiments of the invention, the functionality of one or more of the femtocell basestations 14, 16 can be incorporated into the respective Residential Gateway 94, 102.

In the case illustrated in FIG. 3, the management system 36 allows the establishment of the connection between the femtocell basestations 14, 16 by providing the IP address of the slave device 16 to the master device 14, and the IP address of the master device 14 to the slave device 16. These IP addresses are exposed at the respective edges 106, 108 of the operator's network 28a.

The slave device 16 can then connect peer to peer by means of an IPSec tunnel 110 over the operator's secure IP packet network 28a to the master device 14. The firewalls are open for the IPSec tunnel 110, and so there is no issue with them.

In operation, the management system 36 will need to co-ordinate with the network DHCP to ensure that the IP addresses for the exposed IPSec remain the same, and will need to update the information provided to the femtocell basestations if they change.

As an alternative, the internet can be used as a transport mechanism for sending synchronisation information between the master and slave, but this requires the transit of NATs and firewalls (not shown In FIG. 4).

As shown in FIG. 4, the femtocell basestation (FBS) 14 again contains a “master” software application 90, connected to a NAT (Network Address Transversal) device 92, and is connected to the internet 28b through a Residential Gateway (RG) 94, which also contains a NAT (Network Address Transversal) device 96. Similarly, the femtocell basestation (FBS) 16 contains a “slave” software application 98, connected to a NAT (Network Address Transversal) device 100, and is connected to the internet 28b through a Residential Gateway (RG) 102, which also contains a NAT (Network Address Transversal) device 104.

A large amount of Internet usage follows the client/server mode. In that mode, the application on the host requests data from a server in the network. By sending this request, the NAT and Firewall in the host node are opened in both upstream and downstream directions, and enable the downstream data to reach the application on the host, while the network server is effectively open to client request information.

This situation does not apply here, as if the clock slave “application” 98 were to try to connect peer to peer to the master clock application 90 on the femtocell basestation 14, it would find that application protected by NATs and Firewalls.

The NATs, for security reasons, only allow incoming traffic from an outside address if an outgoing packet has already been sent to that outside address. This means that the master/slave behind different NATs cannot set-up connections to each other in the usual way.

Therefore, Simple Traversal of UDP Through NAT (STUN) and Traversal Using Relay NAT (TURN) protocols are required to determine the type of NAT and firewall that the master/slave is behind, and then to allow the establishment of the required connection. The STUN and TURN protocols may reside in an internet management system server 36 that provides the IP connection information for the master and slave devices.

As the synchronisation information is sent in UDP, the STUN protocol provides a mechanism for the synchronisation packets to traverse a NAT. The STUN protocol allows a client to obtain a transport address (and an IP address and port), which is used for receiving packets from a peer. However, addresses obtained by STUN may not be usable by all peers. Which addresses work depends on the topological conditions of the network. Therefore, STUN by itself cannot provide a complete solution for NAT traversal. A complete solution requires a mechanism by which a client can obtain a transport address from which it can receive synchronisation packets from any peer that can send packets to the public internet. This can only be accomplished by relaying data though a server that resides on the public internet, and in this case this server can be the internet management system server 36. The TURN protocol allows a client to obtain IP addresses and ports from such a relay.

The respective NAT blocks 92, 96, 100, 104 are therefore able to translate the IP addresses as required, and as shown in FIG. 4, in order to allow the required connection to be established and maintained.

A further possibility is to use the Session Initiation Protocol (SIP) to request that IMS (IP Multimedia Subsystem) establishes a connection between master and slave, similar to the establishment of a voice call. Using SIP and IMS can enable a high priority IP transport connection to be established between the synchronization master and slave femtocell basestations.

As shown in FIG. 5, the femtocell basestation (FBS) 14 again contains a “master” software application 90, connected to a NAT (Network Address Transversal) device 92, and is connected to an IP network 28c through a Residential Gateway (RG) 94, which also contains a NAT (Network Address Transversal) device 96. Similarly, the femtocell basestation (FBS) 16 contains a “slave” software application 98, connected to a NAT (Network Address Transversal) device 100, and is connected to the internet 28b through a Residential Gateway (RG) 102, which also contains a NAT (Network Address Transversal) device 104.

As is conventional, the IMS includes servers 112 providing the Call Session Control Functions (CSCFs), and these can belong to the mobile network operator, or to a fixed network provider. Each RG 94, 102 is connected to the IP network 28c through a respective border gateway (BGW) 114, 116 that can be a Packet Data Gateway (PDG), or a Border Gateway Function as per an ETSI TISPAN IMS. In the case of the ETSI TISPAN architecture, the DSL network elements can be controlled via the SIP signalling to provide the required quality of service.

Thus, the use of IMS and SIP provides a peer to peer transport path for synchronization to be established.

Once the connection between the master device 14 and the slave device 16 is set up, the master 14 can send sync messages over the IP Network 28c (by means of an aggregation network which is not shown in FIG. 5) to the slave 16. Thus, the synchronization packets can be embedded in transport paths that may already have been set up.

There is thus described a system which allows master slave synchronization connectivity, and thus allows each femtocell basestation to establish the required degree of frequency synchronization in a resilient way, without needing a highly specified crystal oscillator, and without requiring every femtocell basestation to be able to obtain its synchronization over the wireless interface. This therefore allows the required frequency synchronization to be established with reduced total expenditure.

1. A basestation, for use in a mobile communications network, the basestation comprising:
a frequency synthesizer, for generating signals at desired frequencies;
a wireless communications interface, for transmitting and receiving signals in the mobile communications network; and
a packet data interface, for transmitting and receiving packet data signals over a wide area network,
wherein the basestation is adapted to receive a signal from a first other basestation of the mobile communications network over said wireless communications interface, and to synchronize the frequency synthesizer with the signals received from the first other basestation of the mobile communications network; and
wherein the basestation is adapted to transmit a signal to a second other basestation of the mobile communications network over said packet data interface, such that the second other basestation of the mobile communications network is able to synchronize its frequency synthesizer with the signals transmitted from the basestation.

2. A basestation as claimed in claim 1,wherein the basestation is adapted to receive the signal from the first other basestation of the mobile communications network over said wireless communications interface using one of the downlink frequencies of the mobile communications network.

3. A basestation as claimed in claim 1 or 2, wherein the basestation is adapted to inform a management node of the mobile communications network on synchronization of the frequency synthesizer with the signals received from the first other basestation of the mobile communications network.

4. A basestation as claimed in claim 1 or 2, wherein the basestation is adapted to transmit the signal to the second other basestation of the mobile communications network in response to a command from a management node of the mobile communications network.

5. A management node for a mobile communications network, the network comprising a plurality of basestations, and each of said basestations comprising:
a frequency synthesizer, for generating signals at desired frequencies; and
a packet data interface, for transmitting and receiving packet data signals over a wide area network,
wherein the management node is adapted to receive signals from said basestations, said signals indicating whether the respective basestations have been able to achieve synchronization of their respective frequency synthesizers; and
wherein the management node is adapted to transmit commands to selected basestations of the mobile communications network, such that, in response to said commands, each of the basestations of the mobile communications network is able to achieve synchronization of its respective frequency synthesizer.

6. A management node as claimed in claim 5, wherein the management node is adapted to receive and act on signals from basestations, indicating that said basestations have been able to achieve synchronization of their respective frequency synthesizers.

7. A management node as claimed in claim 5, wherein the management node is adapted to receive and act on signals from basestations, indicating that said basestations have not been able to achieve synchronization of their respective frequency synthesizers.

8. A management node as claimed in claim 5, wherein the management node is adapted to receive and act on signals from each of said basestations, said signals indicating whether the respective basestations have been able to achieve synchronization of their respective frequency synthesizers.

9. A management node as claimed in one of claims 5 to 8, wherein the management node is adapted to transmit commands to selected basestations of the mobile communications network, such that, in response to said commands, each of the selected basestations transmits a frequency synchronization signal to at least one other basestation of the mobile communications network.

10. A management node as claimed in one of claims 5 to 8, wherein the management node is adapted to transmit commands to selected basestations of the mobile communications network, such that, in response to said commands, each of the selected basestations allows the establishment of a communication path with at least one other of the selected basestations, and thereby allows the transmission of frequency synchronization signals between the selected basestations.
